(19) United States
(12) Patent Application Publication
(10) Pub. No.: US 2026/0175616 A1
(43) Pub. Date: Jun. 25, 2026

(54) DECORATIVE PANEL AND METHOD FOR MANUFACTURING A DECORATIVE PANEL

(71) Applicant: Unilin, BV, Wielsbeke (BE)

(72) Inventor: Beauregard BOUTMANS, Wielsbeke (BE)

(73) Assignee: Unilin, BV, Wielsbeke (BE)

(21) Appl. No.: 19/084,893

(22) Filed: Mar. 20, 2025

Related U.S. Application Data
(60) Provisional application No. 63/736,635, filed on Dec. 20, 2024.

(51) Int. Cl. B44C 5/04; B41M 3/00; B41M 5/00; B44F 9/02

(52) U.S. Cl. CPC B44C 5/0446; B41M 3/005; B41M 5/0041; B44F 9/02

(57) ABSTRACT

A decorative panel may have at least an upper visible surface that has a decorative pattern and an identification pattern. The identification pattern may be non-visible by the human eye and detectable by a detecting device. The decorative pattern may include at least one region having an average color having a saturation value. The identification pattern may be formed by a plurality of pattern elements distributed on at least a portion of the visible surface. The pattern elements may each have a color that has a different saturation value than the saturation value of the average color of the region of the decorative pattern wherein the plurality of pattern elements are situated.

This application claims priority under 35 USC 119(e) from U.S. Provisional Patent Application No. 63/736,635 filed Dec. 20, 2024, the entire contents of which are incorporated herein by reference.

### BACKGROUND

### 1. Field

The present invention relates to decorative panels, for example floor, wall or ceiling panels, of the kind having at least one surface that comprises a decorative pattern. More particularly the invention concerns decorative panels wherein the decorative pattern comprises an identification pattern in the form of a concealed code, namely a code that, once read can return predetermined information, and that is normally not visible by the human eye. It is noted that, in the context of the application, decorative panel can encompass any kind of panel or board shaped product to be used as a decorative surface element like, for example: laminate panels, for example DPL, HPL, resilient panels, for example LVT, WPC or SPC, ceramic slabs or tile, engineered stone slabs.

### 2. Discussion of Related Art

WO2019/072733A1 discloses an inkjet printing method for manufacturing decorative laminate panels ordered by a customer. The method includes the steps of: i) providing an inkjet printing device with a print job including one or more decorative patterns and an identification code assigned to the one or more decorative patterns; and ii) printing the one or more decorative patterns with one or more inkjet inks and applying the identification code on a substrate web. The substrate web is a paper substrate. The identification code can be concealed in one or more decorative patterns with steganographic techniques.

A concealed code, or identification pattern, can be included into the decorative pattern by means of a process wherein an image file of the decorative pattern is modified to include the concealed code. This operation can be performed by means of a steganographic technique that modifies the decorative pattern so that the image is modified to include the concealed code. When the concealed code is to be included in a decorative pattern being rather intricate like a wood imitating pattern, it is a challenge to obtain a code that is sufficiently readable without affecting the aesthetic of the decorative pattern. A similar challenge, is present also in case of very light colored and plain decorative patterns, like for example decorative patterns imitating natural stones or marble.

### SUMMARY

The present invention aims in the first place to provide an alternative decorative panel and a method for manufacturing a decorative panel, which, in accordance with several of its preferred embodiments, is directed to solve one or more of the problems arising in the state of the art.

A first aspect of the invention relates to a decorative panel having at least an upper visible surface, said visible surface comprising a decorative pattern and an identification pattern, preferably said identification pattern being non-visible by the human eye and being detectable by a detecting device, wherein said decorative pattern comprises at least one region having an average color having a saturation value, wherein said identification pattern is formed by a plurality of pattern elements distributed on at least a portion of said visible surface, wherein the pattern elements each comprise a color that has a different saturation value than the saturation value of the average color of the region of the decorative pattern wherein said plurality of pattern elements are situated.

The upper visible surface of the decorative panel may be the surface that is visible to an observer when looking at said decorative panel in its installed state. It may be beneficial that said identification pattern is non-visible by the human eye, so that the visual appearance of the decorative panel is not disturbed.

It is preferred that said identification pattern is configured to be detected and preferably interpreted by detecting device, preferably an optical reading device, preferably in combination with dedicated signal processing software. Examples of such an optical reading device include an optical scanning device, a camera, preferably a smartphone camera, an optical mark reader, and the like.

Preferably, said identification pattern comprises information or a link to a digital location comprising information on at least one, preferably on a combination of two or more of the following: manufacturing process, product details, material composition, supplier details, instructions for the customer, of the sheet material and/or of the decorative panel. Such a digital location may be a database, or a location within a database or a website-page, and the like. It is preferred that said information is made available upon decryption, preferably by dedicated decryption software and/or by a dedicated decryption key. Said dedicated decryption software and/or said dedicated decryption key may be comprised within a mobile application configured to run on a smartphone and/or a computer program configured to run on a computer. Said information may have multiple advantages, for example ensuring that the product is authentic and thereby limiting the risk of counterfeit products, provide the end-consumer with instructions on how to install the decorative panel comprising said sheet material, providing relevant information for waste management and recycling facilities.

It may be preferable that said identification pattern comprises multiple encryption levels, for example wherein person A, for example the end-consumer, has access to a first layer of information by using dedicated decryption software A and/or by using dedicated decryption key A; and where person B, for example a worker at a recycling facility, has access to a second layer of information, and perhaps also to said first layer of information, by using dedicated decryption software B and/or by using dedicated decryption key B. This way the producer is able to control who gets to see which information about the decorative panel.

Said plurality of pattern elements may be pixels or dots, preferably printed pixels or dots distributed on at least a portion of said visible surface.

Preferably the average color is defined by a coordinate in the HSB (hue, saturation, brightness) color model, for example wherein the saturation value of a pattern element relates to a point on the saturation axis on which the average color is situated, as represented by the HSB color model.

Preferably said plurality of pattern elements comprises at least a first pattern element and/or a second pattern element. By having a plurality of pattern element types the diversity in identification patterns may be increased.

It is preferred that said first pattern element comprises a color having a saturation value that is higher than the saturation value of the average color of the region of the decorative pattern wherein said plurality of pattern elements are situated.

Preferably, the saturation value of the color of the first pattern element is at least 3% higher, preferably at least 5% higher, more preferably at least 10% higher than the saturation value of the average color of the region of the decorative pattern wherein said plurality of pattern elements are situated. The inventor has found that the identification pattern may be better concealed on said visible surface in this manner.

It is preferred that said second pattern element comprises a color having a saturation value that is lower than the saturation value of the average color of the region of the decorative pattern wherein said plurality of pattern elements are situated.

Preferably, the saturation value of the color of the first pattern element is at least 3% lower, preferably at least 5% lower, more preferably at least 10% lower than the saturation value of the average color of the region of the decorative pattern wherein said plurality of pattern elements are situated. The inventor has found that the identification pattern may be better concealed on said visible surface in this manner.

It is preferred that said identification pattern comprises a plurality of first pattern elements and/or a plurality of second pattern elements.

In a preferred embodiment, said identification pattern is made up from a plurality of first pattern elements and a plurality of second pattern elements. The inventor has found that the identification pattern may be concealed even better if the identification pattern comprises first pattern elements having a higher saturation value than the average color of the region in which said pattern elements are situated and second pattern elements having a saturation value lower than the average color of the region in which said pattern elements are situated.

Preferably, a hue value and/or a brightness value of a pattern element is substantially the same as the hue value and/or the brightness value of the average color of the region of the decorative pattern wherein said plurality of pattern elements are situated.

It is preferred that said hue value of the average color relates to a point on the hue-axis as represented by the HSB color model and wherein said brightness value of the average color relates to a point on the brightness-axis as represented by the HSB color model.

Preferably said decorative pattern comprises a singular region, comprising an average color, wherein said singular region encompasses the entire decorative pattern. The inventor found that especially in the case wherein the decorative pattern has little color variation, it may be beneficial to limit the decorative pattern to a singular region having an average color, in order to limit the complexity of the identification pattern.

In an alternative embodiment said decorative pattern comprises more than one region having an average color as defined by a coordinate in the HSB color model. This may be especially beneficial for decorative patterns having a significant amount of color variation.

It is preferred that the average color of a first region and the average color of any other region differ more than 5 degrees on the hue axis, preferably more than 10 degrees on the hue axis and/or differ more than 5 percent on the value-axis representing brightness, preferably more than 10 percent on the value-axis.

Preferably, the identification pattern of a first region is different from the identification pattern in any other region. This is especially beneficial in the case a first region has a first average color wherein the identification pattern of said first region comprises a plurality of pattern elements having a different saturation value than said first average color, and another region having another average color wherein the other identification pattern of said other region comprises a plurality of pattern elements having a different saturation value than said other average color.

It is preferred that the decorative panel is a floor, wall, ceiling or furniture panel, preferably a laminate panel, preferably comprising a wood-based or a polymer-based panel, a ceramic slab, a mineral-based board, cement-based board, or an engineered stone slab.

Preferably the decorative panel is of the type comprising a base layer and a top layer, said top layer comprising the decorative pattern.

Preferably, at least one between the decorative pattern and the identification pattern is digitally printed.

Preferably, the identification pattern is formed by a plurality of printed dots.

Preferably, the identification pattern is distributed of the entirety of the visible surface. This further increases the readability of the identification pattern as the identification pattern can be read from multiple locations of the decorative panel.

It is also preferred that the visible surface comprises a plurality of repetitions of said identification pattern, preferably wherein said visible surface is substantially entirely covered by said identification pattern or by repetitions of said identification pattern. Having multiple repetitions of the identification pattern ensures that even if part of the decorative panel is damaged or obscured, the identification pattern can still be read on another part of said decorative panel.

It is preferred that said portion is the minimum area of the visible surface that can contain a minimum fraction of the identification pattern that allows the readability of the identification pattern itself.

Preferably said portion is lower than 5 square centimeters, preferably lower than 2 square centimeters.

In a preferred embodiment, the decorative panel comprises a transparent or translucent layer above the decorative pattern and the identification pattern. Such transparent or translucent layer may be a wear layer and/or a protective layer.

Preferably the decorative pattern is a natural wood imitation or a natural stone imitation or a natural material imitation or a fantasy pattern.

A second aspect of the invention relates to a method for manufacturing a decorative panel, preferably in accordance with any of the preceding claims, comprising the steps of:
providing an initial decorative pattern;
dividing said initial decorative pattern into one or more regions;
determining an average color for said one or more regions;
generating an identification pattern for being applied on a visible surface of the decorative panel, wherein said identification pattern is formed by a plurality of pattern elements distributed on at least a portion of said visible surface;
applying said decorative pattern and said identification pattern on a substrate, preferably a printable substrate and forming a decorative panel; wherein the pattern elements each comprise a color that has a different saturation value than the saturation value of the average color of the region of the decorative pattern wherein said plurality of pattern elements are applied.

Preferably said average color is defined by a coordinate in the HSB (hue, saturation, brightness) color model, for example wherein the saturation value of a pattern element relates to a point on the saturation axis on which the average color is situated, as represented by the HSB color model.

Preferably, said plurality of pattern elements comprise at least a first pattern element and/or a second pattern element.

Preferably, said first pattern element comprises a color having a saturation value that is higher than the saturation value of the average color of the region of the decorative pattern wherein said plurality of pattern elements are situated.

Preferably, the saturation value of the color of the first pattern element is at least 3% higher, preferably at least 5% higher, more preferably at least 10% higher than the saturation value of the average color of the region of the decorative pattern wherein said plurality of pattern elements are situated.

It is preferred that said second pattern element comprises a color having a saturation value that is lower than the saturation value of the average color of the region of the decorative pattern wherein said plurality of pattern elements are situated.

Preferably, the saturation value of the color of the first pattern element is at least 3% lower, preferably at least 5% lower, more preferably at least 10% lower than the saturation value of the average color of the region of the decorative pattern wherein said plurality of pattern elements are situated.

It is preferred that said identification pattern comprises a plurality of first pattern elements and/or a plurality of second pattern elements.

Preferably, a hue value and/or a brightness value of a pattern element is substantially the same as the hue value and/or the brightness value of the average color of the region of the decorative pattern wherein said plurality of pattern elements are situated.

In a preferred embodiment, the step of dividing said initial decorative pattern into one or more regions, involves identifying one or more regions in said decorative pattern, wherein each of said one or more identified regions has an initial average color that differs from the initial average color of another of said one or more identified regions.

It is preferred that the initial average color of a first region and the initial average color of any other region differ more than 5 degrees on the hue axis, preferably more than 10 degrees on the hue axis and/or differ more than 5 percent on the value-axis representing brightness, preferably more than 10 percent on the value-axis.

It may be that said decorative pattern is scanned, for example in an image processing software and that said decorative pattern is divided into a plurality of different regions based on the average initial color of said individual regions. For example, a piece of software and/or an algorithm may attribute a color coordinate on the HSB color model for each pixel of the decorative pattern. Said piece of software and/or algorithm may further be able to group a plurality of adjacent pixels based on their color coordinates lying within a specific interval for hue, saturation and/or brightness values. A group of pixels wherein the respective color coordinates of each pixel within said group falls within said specific interval may then form a region having an initial average color. Another group of pixels wherein the respective color coordinates of each pixel within said other group falls within another specific interval may then form another region having another initial average color.

After said step of dividing said initial decorative pattern into one or more regions, an average color is attributed to said one or more regions. Preferably, said average color of a region is the same as the initial average color of said region. Said average color of a region may be used as a basis for determining the saturation value of a first and/or a second pattern element within said identification pattern.

It is preferred that the identification pattern of a first region is different from the identification pattern in any other region.

It is preferred that the step of providing an initial decorative pattern; and/or the step of dividing said initial decorative pattern into one or more regions; and/or the step of determining an average color for said one or more regions, are carried out in an imaging processing software, preferably Photoshop.

In a preferred embodiment, the method comprises the step of generating a printing pattern involving either:
integrating said identification pattern into said initial decorative pattern; or
overlaying said identification pattern onto said initial decorative pattern.

Said printing pattern may be a digital file.

Preferably, the step of generating a printing pattern is carried out in an imaging processing software, preferably Photoshop.

It is preferred that the printing pattern is printed onto a surface of the decorative panel or on a carrier to be applied onto the decorative panel forming the visible surface of the decorative panel during the step of applying said decorative pattern and said identification pattern.

Preferably, the step of applying said decorative pattern and/or said identification pattern is carried out by a printing technique, preferably a digital printing technique, more preferably a digital inkjet printing technique.

It is preferred that said decorative pattern and said identification pattern are printed in the same printing operation.

Preferably, the step of applying said decorative pattern and said identification pattern is carried out by a single-pass printer or by a multi-pass printer.

Preferably, said decorative panel is a floor, wall, ceiling or furniture panel, preferably a laminate panel, preferably comprising a wood-based or a polymer-based panel, a ceramic slab, a mineral-based board, cement-based board, or an engineered stone slab.

Preferably, the decorative panel is of the type comprising a base layer and a top layer, said top layer comprising the decorative pattern.

It is preferred that the substrate is a base layer of said decorative panel or an intermediate layer provided on said base layer, preferably an ink receiver layer or that the substrate is a carrier, preferably a printable paper or a printable thermoplastic foil.

Preferably, the substrate is a carrier and the method comprises the step of laminating said carrier on a base layer of said decorative panel.

### BRIEF DESCRIPTION OF THE DRAWINGS

With the intention of better showing the characteristics of the invention, herein below, as an example without any limitative character, some preferred embodiments are described, with reference to the accompanying drawings, wherein:

FIG. 1 is a perspective drawing representing a decorative panel according to the first aspect of the invention;

FIG. 2, at a larger scale, is a top view of the area indicated with F2 in FIG. 1;

FIG. 3, at a larger scale is a view of the area indicated with F3 in FIG. 2;

FIG. 4, at a larger scale is a view of the area indicated with F4 in FIG. 2;

FIG. 5, at a larger scale, is a cross-section along the line indicated with V-V in FIG. 1; and

FIG. 6 is a schematic representation of a method in accordance with the second aspect of the invention.

### DESCRIPTION OF NON-LIMITING EMBODIMENTS

FIG. 1 shows a decorative panel 1, more particularly a floor panel 1. The decorative panel 1 is rectangular and oblong and has an upper visible surface 2 comprising a decorative pattern 3.

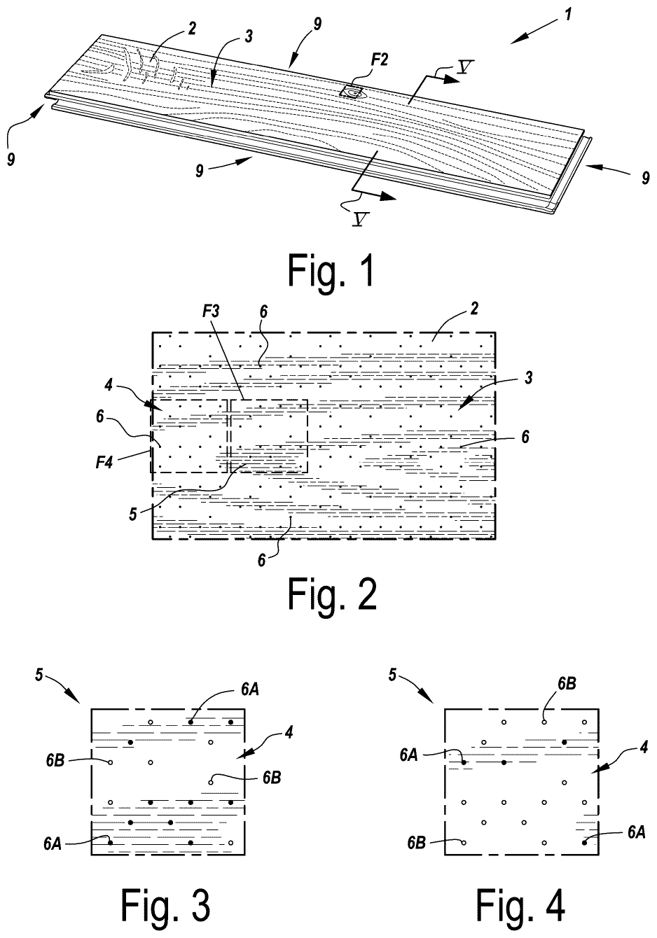

A more detailed view of the area indicated with F2 in FIG. 1 is shown in FIG. 2, revealing that the upper visible surface 2 additionally comprises an identification pattern 4. The identification pattern 4 is preferably not visible to the naked eye in the decorative panel 1 so that the natural appearance of the upper visible surface 2 is not disturbed. The identification pattern 4 is preferably detectable by a detecting device such as an optical reading device, for example a smartphone camera.

Said decorative pattern comprises at least one region 5 having an average color having a saturation value. The identification pattern 4 is formed by a plurality of pattern elements 6 distributed on at least a portion of said visible surface 2. The pattern elements 6 each comprise or consist of a color that has a different saturation value than the saturation value of the average color of the region 5 of the decorative pattern 3 wherein said plurality of pattern elements 6 are situated.

The plurality of pattern elements 6 in FIG. 3 comprises at least a first pattern element 6A and a second pattern element 6B. The first pattern element 6A has a saturation value that is higher than the saturation value of the average color of the region 5 of the decorative pattern 3 wherein said plurality of pattern elements 6 are situated. The second pattern element 6B has a saturation value that is lower than the saturation value of the average color of the region 5 of the decorative pattern 3 wherein said plurality of pattern elements 6 are situated.

FIG. 4 shows another region 5 of the decorative pattern 3 having a different average color than the average color of the region 5 as shown in FIG. 3. The region 5 as shown in FIG. 4 comprises a plurality of pattern elements 6 which comprises at least a first pattern element 6A and a second pattern element 6B. The first pattern element 6A has a saturation value that is higher than the saturation value of the average color of the region 5 of the decorative pattern 3 wherein said plurality of pattern elements 6 are situated. The second pattern element 6B has a saturation value that is lower than the saturation value of the average color of the region 5 of the decorative pattern 3 wherein said plurality of pattern elements 6 are situated.

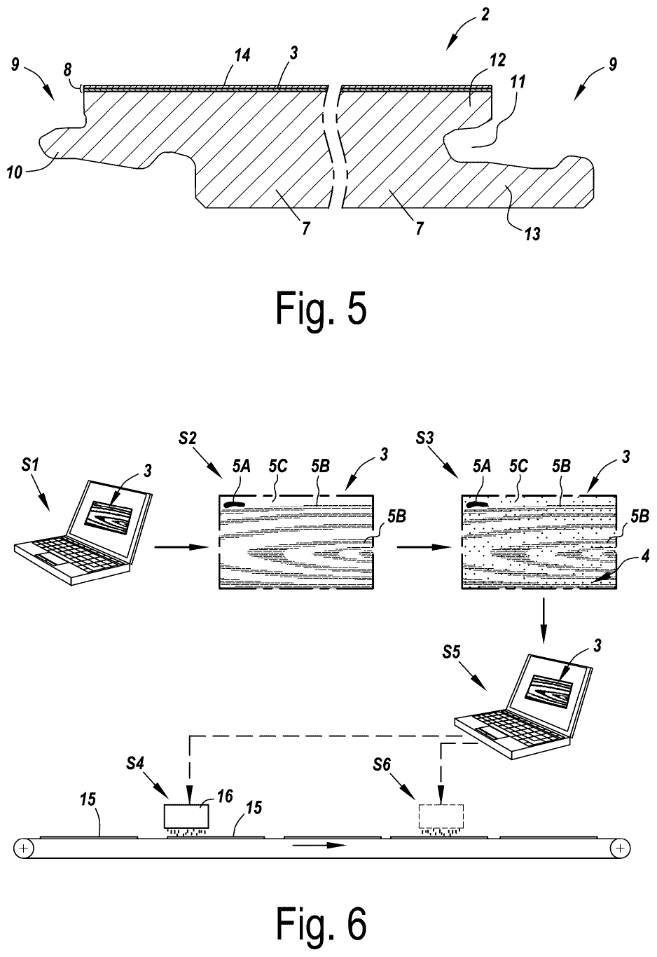

The decorative panel 1 comprises a base layer 7 and a top layer 8 comprising the decorative pattern 3, as shown in FIG. 5. The base layer 7 of the decorative panel 1 is provided with coupling means 9. Said coupling means 9 are formed as a tongue 10 on one side of the panel 1 and a groove 11 on an opposite side of the panel 1, wherein a tongue 10 of one panel 1 is able to be inserted into a groove 11, delimited by an upper lip 12 and a lower lip 13, of another panel 1 in order to effect a locking, preferably in a horizontal direction substantially parallel to the upper visible surface 2 of the panel and preferably in vertical direction substantially perpendicular to the upper visible surface 2 of the panel 1. The decorative panel 1 as shown in FIG. 5 comprises a transparent or translucent layer 14 above the decorative pattern 3 and the identification pattern 4.

FIG. 6 shows a method for manufacturing a decorative panel in accordance with the second aspect of the invention. The method comprises the steps of:
providing S1 an initial decorative pattern 3;
dividing S2 said initial decorative pattern 3 into one or more regions 5A, 5B, 5C;
determining an average color for said one or more regions 5A, 5B, 5C;
generating S3 an identification pattern 4 for being applied on a visible surface 2 of the decorative panel 1, wherein said identification pattern 4 is formed by a plurality of pattern elements 6 distributed on at least a portion of said visible surface 2;
applying S4 said decorative pattern 3 and said identification pattern 4 on a substrate 15, preferably a printable substrate 15 and forming a decorative panel 1 comprising said substrate 15, this step of applying S4 is preferably performed by means of a printer 16, preferably a digitally controlled printer 16, preferably a single pass printer 16;
   wherein the pattern elements 6 each comprise a color that has a different saturation value than the saturation value of the average color of the region 5 of the decorative pattern 3 wherein said plurality of pattern elements 6 are applied.

The step of providing an initial decorative pattern 3 as well as the step of dividing S2 said initial decorative pattern 3 into one or more regions 5 and the step of determining an average color for said one or more regions 5 are carried out in an imaging processing software, for example Photoshop.

The method additionally comprises the step S5 of generating a printing pattern involving either integrating said identification pattern 4 into said initial decorative pattern 3 or overlaying said identification pattern 4 onto said initial decorative pattern 3. This step of generating S5 a printing pattern is carried out in an imaging processing software, for example Photoshop.

The printing pattern is printed onto a surface of the decorative panel 1 or on a carrier 15 to be applied onto the decorative panel 1 forming the visible surface 2 of the decorative panel 1 during the step of applying S4 said decorative pattern 3 and said identification pattern 4.

In the shown embodiment of FIG. 6, the step of applying S4 said decorative pattern 3 and/or said identification pattern 4 is carried out by a printing technique, preferably a digital printing technique, preferably a digital inkjet printing technique. Said decorative pattern 3 and said identification pattern 4 can be printed in the same printing operation S4 or said decorative pattern 3 can be printed in a first printing operation S4 and said identification pattern 4 can be printed in a second printing operation S6.

The invention is further disclosed by the following paragraph list as defined by the below numbered paragraphs.
1. A decorative panel (1) having at least an upper visible surface (2), said visible surface (2) comprising a decorative pattern (3) and an identification pattern (4), preferably said identification pattern (4) being non-visible by the human eye and being detectable by a detecting device, wherein said decorative pattern (3) comprises at least one region (5) having an average color having a saturation value, wherein said identification pattern (4) is formed by a plurality of pattern elements (6) distributed on at least a portion of said visible surface (2), wherein the pattern elements (6) each comprise a color that has a different saturation value than the saturation value of the average color of the region (5) of the decorative pattern (3) wherein said plurality of pattern elements (6) are situated.
2. The decorative panel in accordance with claim 1, wherein the average color is defined by a coordinate in the HSB (hue, saturation, brightness color model, for example wherein the saturation value of a pattern element (6) relates to a point on the saturation axis on which the average color is situated, as represented by the HSB color model.
3. The decorative panel in accordance with claim 1 or 2, wherein said plurality of pattern elements (6) comprises at least a first pattern element (6A) and/or a second pattern element (6B).
4. The decorative panel in accordance with claim 3, wherein said first pattern element (6A) comprises a color having a saturation value that is higher than the saturation value of the average color of the region (5) of the decorative pattern (3) wherein said plurality of pattern elements (6) are situated.
5. The decorative panel in accordance with claim 4, wherein the saturation value of the color of the first pattern element (6A) is at least 3% higher, preferably at least 5% higher, more preferably at least 10% higher than the saturation value of the average color of the region (5) of the decorative pattern (3) wherein said plurality of pattern elements (6) are situated.
6. The decorative panel in accordance with any of the claims 3 to 5, wherein said second pattern element (6B) comprises a color having a saturation value that is lower than the saturation value of the average color of the region (5) of the decorative pattern (3) wherein said plurality of pattern elements (6) are situated.
7. The decorative panel in accordance with claim 6, wherein the saturation value of the color of the second pattern element (6B) is at least 3% lower, preferably at least 5% lower, more preferably at least 10% lower than the saturation value of the average color of the region (5) of the decorative pattern (3) wherein said plurality of pattern elements (6) are situated.
8. The decorative panel in accordance with any of the claims 3 to 7, wherein said identification pattern (4) comprises a plurality of first pattern elements (6A) and/or a plurality of second pattern elements (6B).
9. The decorative panel in accordance with any of the preceding claims, wherein a hue value and/or a brightness value of a pattern element (6) is substantially the same as the hue value and/or the brightness value of the average color of the region (5) of the decorative pattern (3) wherein said plurality of pattern elements (6) are situated.
10. The decorative panel in accordance with claim 9, wherein said hue value of the average color relates to a point on the hue-axis as represented by the HSB color model and wherein said brightness value of the average color relates to a point on the brightness-axis as represented by the HSB color model.
11. The decorative panel in accordance with any of the preceding claims, wherein said decorative pattern (3) comprises a singular region (5), comprising an average color, wherein said singular region (5) encompasses the entire decorative pattern (3).
12. The decorative panel in accordance with any of the preceding claims, wherein said decorative pattern (3) comprises more than one region (5) having an average color as defined by a coordinate in the HSB color model.
13. The decorative panel in accordance with claim 12, wherein the average color of a first region (5A) and the average color of any other region (5B) differ more than 5 degrees on the hue axis, preferably more than 10 degrees on the hue axis and/or differ more than 5 percent on the value-axis representing brightness, preferably more than 10 percent on the value-axis.
14. The decorative panel in accordance with claim 12 or 13, wherein the identification pattern (4) of a first region (5A) is different from the identification pattern (4) in any other region (5B).
15. The decorative panel in accordance with any of the preceding claims, being a floor, wall, ceiling or furniture panel (1).
16. The decorative panel in accordance with any of the preceding claims, being a laminate panel (1), preferably comprising a wood-based or a polymer-based panel (1), a ceramic slab, a mineral-based board, cement-based board, or an engineered stone slab.
17. The decorative panel in accordance with any of the preceding claims, being of the type comprising a base layer (7) and a top layer (8), said top layer comprising the decorative pattern (3).
18. The decorative panel in accordance with any of the preceding claims, wherein at least one between the decorative pattern (3) and the identification pattern (4) is digitally printed.
19. The decorative panel in accordance with claim 16, wherein the identification pattern (4) is formed by a plurality of printed dots (6).
20. The decorative panel in accordance with any of the preceding claims, wherein the identification pattern (4) is distributed over the entirety of the visible surface (2).
21. The decorative panel in accordance with any of the preceding claims, wherein the visible surface (2) comprises a plurality of repetitions of said identification pattern (4), preferably wherein said visible surface (2) is substantially entirely covered by said identification pattern (4) or by repetitions of said identification pattern (4).
22. The decorative panel in accordance with any of the preceding claims, wherein said portion is the minimum area of the visible surface that can contain a minimum fraction of the identification pattern (4) that allows the readability of the identification pattern (4) itself.
23. The decorative panel in accordance with any of the preceding claims, wherein said portion is preferably lower than 5 square centimeters, even more preferably lower than 2 square centimeters.
24. The decorative panel in accordance with any of the preceding claims wherein the panel (1) comprises one transparent or translucent layer (14) above the decorative pattern (3) and the identification pattern (4).
25. The decorative panel in accordance with any of the preceding claims, wherein the decorative pattern (3) is a natural wood imitation or a natural stone imitation or a natural material imitation or a fantasy pattern.
26. A method for manufacturing a decorative panel (1), preferably in accordance with any of the preceding claims, comprising the steps of:
   Providing (S1) an initial decorative pattern (3);
   dividing said initial decorative pattern (3) into one or more regions (5);
   determining an average color for said one or more regions (5);
   generating an identification pattern (4) for being applied on a visible surface (2) of the decorative panel (1), wherein said identification pattern (4) is formed by a plurality of pattern elements (6) distributed on at least a portion of said visible surface (2);
   applying said decorative pattern (3) and said identification pattern (4) on a substrate (15), preferably a printable substrate (15) and forming a decorative panel (1) comprising said substrate (15);
      wherein the pattern elements (6) each comprise a color that has a different saturation value than the saturation value of the average color of the region (5) of the decorative pattern (3) wherein said plurality of pattern elements (6) are applied.
27. The method in accordance with claim 26, wherein said average color is defined by a coordinate in the HSB (hue, saturation, brightness) color model and wherein the saturation value of a pattern element (6) relates to a point on the saturation axis on which the average color is situated, as represented by the HSB color model.
28. The method in accordance with claim 26 or 27, wherein said plurality of pattern elements (6) comprise at least a first pattern element (6A) and/or a second pattern element (6B).
29. The method in accordance with claim 28, wherein said first pattern element (6A) comprises a color having a saturation value that is higher than the saturation value of the average color of the region (5) of the decorative pattern (3) wherein said plurality of pattern elements (6) are situated.
30. The method in accordance with claim 29, wherein the saturation value of the color of the first pattern element (6A) is at least 3% higher, preferably at least 5% higher, more preferably at least 10% higher than the saturation value of the average color of the region (5) of the decorative pattern (3) wherein said plurality of pattern elements (6) are situated.
31. The method in accordance with any of the claims 28 to 30, wherein said second pattern element (6B) comprises a color having a saturation value that is lower than the saturation value of the average color of the region (5) of the decorative pattern wherein said plurality of pattern elements (6) are situated.
32. The method in accordance with claim 31, wherein the saturation value of the color of the first pattern element (6A) is at least 3% lower, preferably at least 5% lower, more preferably at least 10% lower than the saturation value of the average color of the region (5) of the decorative pattern (3) wherein said plurality of pattern elements (6) are situated.
33. The method in accordance with any of the claims 28 to 32, wherein said identification pattern (4) comprises a plurality of first pattern elements (6A) and/or a plurality of second pattern elements (6B).
34. The method in accordance with any of the claims 28 to 33, wherein a hue value and/or a brightness value of a pattern element (6) is substantially the same as the hue value and/or the brightness value of the average color of the region (5) of the decorative pattern (3) wherein said plurality of pattern elements (6) are situated.
35. The method in accordance with claim 34, wherein said hue value of the average color relates to a point on the hue-axis as represented by the HSB color model, for example wherein said brightness value of the average color relates to a point on the value-axis as represented by the HSB color model.
36. The method in accordance with any of the claims 26 to 35, wherein the step of dividing (S2) said initial decorative pattern (3) into one or more regions (5), involves identifying one or more regions (5) in said decorative pattern (3), wherein each of said one or more identified regions (5) has an initial average color that differs from the initial average color of another of said one or more identified regions (5).
37. The method in accordance with claim 36, wherein the initial average color of a first region (5A) and the initial average color of any other region (5B) differ more than 5 degrees on the hue axis, preferably more than 10 degrees on the hue axis and/or differ more than 5 percent on the value-axis representing brightness, preferably more than 10 percent on the value-axis.
38. The method in accordance with any of the claims 26 to 37, wherein the identification pattern (4) of a first region (5A) is different from the identification pattern (4) in any other region (5B).
39. The method in accordance with any of the claims 26 to 38, wherein the step of providing (S1) an initial decorative pattern; and/or the step of dividing (S2) said initial decorative pattern into one or more regions; and/or the step of determining an average color for said one or more regions, are carried out in an imaging processing software, preferably Photoshop.
40. The method in accordance with any of the claims 26 to 39, wherein the method comprises the step of generating a printing pattern involving either:
   integrating said identification pattern (4) into said initial decorative pattern (3); or
   overlaying said identification pattern (4) onto said initial decorative pattern (3).
41. The method in accordance with claim 40, wherein the step of generating a printing pattern is carried out in an imaging processing software, preferably Photoshop.
42. The method in accordance with claim 40 or 41, wherein the printing pattern is printed onto a surface (15) of the decorative panel (1) or on a carrier (15) to be applied onto the decorative panel (1) forming the visible surface (2) of the decorative panel (1) during the step of applying (S4) said decorative pattern (3) and said identification pattern (4).
43. The method in accordance with any of the claims 26 to 42, wherein the step of applying (S4) said decorative pattern (3) and/or said identification pattern (4) is carried out by a printing technique, preferably a digital printing technique, more preferably a digital inkjet printing technique.
44. The method in accordance with claim 43, wherein said decorative pattern (3) and said identification pattern (4) are printed in the same printing operation (S4).
45. The method in accordance with any of the claims 26 to 44, wherein the step of applying (S4) said decorative pattern (3) and said identification pattern (4) is carried out by a single-pass printer (16) or by a multi-pass printer (16).
46. The method in accordance with any of the claims 26 to 45, wherein said decorative panel (1) is a floor, wall, ceiling or furniture panel.
47. The method in accordance with any of the claims 26 to 46, wherein said decorative panel (1) is a laminate panel, preferably comprising a wood-based or a polymer-based panel, a ceramic slab, a mineral-based board, cement-based board, or an engineered stone slab.
48. The method in accordance with any of the claims 26 to 47, wherein the decorative panel (1) is of the type comprising a base layer (7) and a top layer (8), said top layer (8) comprising the decorative pattern (3).
49. The method in accordance with any of the claims 26 to 48, wherein the substrate (15) is a base layer (7) of said decorative panel (1) or wherein the substrate (15) is a carrier, preferably a printable paper or a printable thermoplastic foil.
50. The method in accordance with claim 49, wherein the substrate (15) is a carrier and wherein the method comprises the step of laminating said carrier on a base layer (7) of said decorative panel (1).

The present invention is in no way limited to the above described embodiments, but such methods, and substrates may be realized according to several variants without departing from the scope of the invention.

1. A decorative panel having at least an upper visible surface, the visible surface comprising:
a decorative pattern; and
an identification pattern;
wherein the decorative pattern has at least one region having an average color having a saturation value;
wherein the identification pattern is formed by a plurality of pattern elements distributed on at least a portion of the visible surface;
wherein the pattern elements each include a color that has a different saturation value than the saturation value of the average color of the region of the decorative pattern wherein said plurality of pattern elements are situated.

2. The decorative panel in accordance with claim 1, wherein the average color is defined by a coordinate in the HSB color model; and
wherein the saturation value of a pattern element relates to a point on the saturation axis on which the average color is situated, as represented by the HSB color model.

3. The decorative panel in accordance with claim 1, wherein the plurality of pattern elements comprises at least a first pattern element and/or a second pattern element.

4. The decorative panel in accordance with claim 3, wherein the first pattern element comprises a color having a saturation value that is higher than the saturation value of the average color of the region of the decorative pattern wherein the plurality of pattern elements are situated.

5. The decorative panel in accordance with claim 4, wherein the saturation value of the color of the first pattern element is at least 3% higher than the saturation value of the average color of the region of the decorative pattern wherein the plurality of pattern elements are situated.

6. The decorative panel in accordance with claim 3, wherein the second pattern element comprises a color having a saturation value that is lower than the saturation value of the average color of the region of the decorative pattern wherein the plurality of pattern elements are situated.

7. The decorative panel in accordance with claim 6, wherein the saturation value of the color of the second pattern element is at least 3% lower than the saturation value of the average color of the region of the decorative pattern wherein the plurality of pattern elements are situated.

8. The decorative panel in accordance with claim 3, wherein the identification pattern comprises a plurality of first pattern elements and/or a plurality of second pattern elements.

9. The decorative panel in accordance with claim 1, wherein a hue value and/or a brightness value of a pattern element is substantially the same as the hue value and/or the brightness value of the average color of the region of the decorative pattern wherein the plurality of pattern elements are situated.

10. The decorative panel in accordance with claim 9, wherein the hue value of the average color relates to a point on the hue-axis as represented by the HSB color model and wherein the brightness value of the average color relates to a point on the brightness-axis as represented by the HSB color model.

11. The decorative panel in accordance with claim 1, wherein the decorative pattern comprises a singular region having an average color; and
wherein the singular region encompasses the entire decorative pattern.

12. The decorative panel in accordance with claim 1, wherein the decorative pattern comprises more than one region having an average color as defined by a coordinate in the HSB color model.

13. The decorative panel in accordance with claim 12, wherein the average color of a first region and the average color of any other region differ more than 5 degrees on the hue axis and/or differ more than 5 percent on the value-axis representing brightness.

14. The decorative panel in accordance with claim 12, wherein the identification pattern of a first region is different from the identification pattern in any other region.

15. The decorative panel in accordance with claim 1, being a floor, wall, ceiling or furniture panel.

16. The decorative panel in accordance with claim 1, being a laminate panel, a ceramic slab, a mineral-based board, cement-based board, or an engineered stone slab.

17. The decorative panel in accordance with claim 1, being of the type comprising a base layer and a top layer, the top layer comprising the decorative pattern.

18. The decorative panel in accordance with claim 1, wherein at least one of the decorative pattern and the identification pattern is digitally printed.

19. The decorative panel in accordance with claim 18, wherein the identification pattern is formed by a plurality of printed dots.

20. The decorative panel in accordance with claim 1, wherein the identification pattern is distributed over the entirety of the visible surface.
